(19) United States
(12) Patent Application Publication
(10) Pub. No.: US 2005/0015726 A1
(43) Pub. Date: Jan. 20, 2005

(54) System, apparatus, and method for frame implementation within a mobile internet browser

(76) Inventor: Jere Tuominen, Hyvinkaa (FI)

Correspondence Address: Crawford Maunu PLLC, Suite 390, 1270 Northland Drive, St. Paul, MN, 55120, US

(21) Appl. No.: 10/447,203

(22) Filed: May 27, 2003

(51) Int. Cl. G06F 15/16

(52) U.S. Cl. 715/733; 715/513

(57) ABSTRACT

A system, apparatus, and method for rendering markup content onto separate navigation and content frames. Each frame definition is rendered onto a separate content window and its corresponding navigational tab is rendered onto the navigation window. All links followed during a browsing session are similarly rendered onto the navigation and content windows, such that navigation through all frames is accomplishing by selecting its corresponding navigation tab. Visual highlighting of the selected navigation tab is provided so that the active content window may be quickly ascertained.

### FIELD OF THE INVENTION

This invention relates in general to internet browsers, and more particularly, to mobile internet browsers for small screen mobile terminal applications.

### BACKGROUND OF THE INVENTION

The mobile industry has experienced a period of exceptional growth during the past several years, where mobile voice and simple Short Message Service (SMS) text messaging have provided the primary drivers for this growth. The next wave of growth is expected to come from new mobile services where content, not just voice, will be mobilized. To insure a successful launch of these new mobile services, service enablers are used to create the mobile services according to at least the following criteria: enablement of new and better services for consumers; provision of facilities to developers to speed up the development of the mobile services; and insuring interoperability through the use of open global standards.

The use of open global standards, such as those endorsed by the Open Mobile Alliance (OMA), minimizes fragmentation of the service enablers and insures seamless interoperability between different vendors. Some of the key service enablers used for the successful take-up of the mobile services include: Multimedia Messaging Service (MMS); Mobile Digital Rights Management (MDRM); and mobile browsing, to name only a few.

The essence of mobile browsing lies in its close alignment with widely accepted internet standards. The Wireless Application Protocol (WAP) Forum and the World Wide Web Consortium (W3C) have successfully defined mobile internet standards over the past several years. Just recently, the WAP Forum has adopted the Extensible HyperText Markup Language (XHTML) Basic standard from the W3C as the basis for the latest revision of WAP. The transition to XHTML Basic will strengthen the position of the mobile browser in the mainstream Internet and allow for a far greater range of presentation and formatting than previously possible.

The essential elements of browsing content includes: a page description language; a content formatting language; and a scripting language. These elements enable consumers to enjoy a wider array of services, more intuitive user interfaces, and a generally more useful experience. At the same time, carriers will be able to exercise more control over the look and feel of services they provide through their mobile portals. According to the W3C specification, XHTML Basic defines a document type that is rich enough to be used for content authoring and precise document layout, yet can be shared across different classes of devices, such as desktop computers, Personal Digital Assistants (PDA), TV, mobile devices, etc.

One of the many challenges presented by mobile browsing, however, is the display size limitation of the mobile device. Frame presentation to certain mobile devices, as it is known in the art, is not practical because of the horizontal size limitations imposed by the mobile device display. Mobile device access to an XHTML frame that has been rendered for a desktop browser, for example, allows only a portion of the frame to be viewed at any given time by the mobile device. Accordingly, navigation throughout the frame entails a series of vertical and horizontal scrolling movements that requires a high degree of laborious interaction by the user.

Additionally, in the prior art, history of the links that are followed during a particular browsing session are kept using a linked list. Thus, a return to any previously visited link requires a backward traversal of each link visited until the correct link is obtained. In other words, if the Uniform Resource Locator (URL) for each visited link can be represented by a letter, then a particular browsing session might yield the following linked list of visited URLs: A-B-C-D-E. Once at URL-E, for example, the only way to return to URL A would be to backtrack from URL E, to URL D, to URL C, to URL B, and then finally to URL A. Such a method of URL navigation tends to needlessly burden the mobile device user, since he or she often prefers to revisit only a small subset of URLs previously visited and does not wish to traverse unwanted URLs to get to the small subset of URLs of interest.

Still further, prior art rendering of XHTML frames causes a mixture of content and navigational links to coexist on the same frame, which tends to clutter and complicate the frame, especially when viewed on a reduced size, mobile device display. As such, not only are precious display resources consumed by the cluttered content, but identification of the cluttered content becomes an arduous task indeed.

Accordingly, there is a need in the communications industry for a system and method that facilitates efficient rendering of markup information onto the limited display area of a mobile device. Further, the markup information should be separated into its content and navigational components so that each component, when displayed separately, consumes a smaller portion of display area, while providing a clearer, more readable view. Still further, an improved method of link navigation is required that precludes the necessity to re-visit each previously visited link in sequence, in order to arrive at the desired link.

### SUMMARY OF THE INVENTION

To overcome limitations in the prior art, and to overcome other limitations that will become apparent upon reading and understanding the present specification, the present invention discloses a system, apparatus, and method for rendering XHTML frames onto a reduced size, mobile device display that yields improved visibility to the rendered content and allows greater navigation flexibility.

In accordance with one embodiment of the invention, a network browsing system is provided. The network browsing system comprises a network having Web pages addressable by a Uniform Resource Locator (URL) and a browsing entity coupled to access the Web pages and coupled to receive markup definitions associated with the Web pages. The browsing entity generates a content window for each frame associated with each Web page and a navigation window having a tab associated with each content window.

In accordance with another embodiment of the invention, a mobile terminal wirelessly coupled to a network having Web pages accessible by a Uniform Resource Locator (URL) is provided. The mobile terminal comprises a memory capable of storing at least one of a mobile browser and a rendering module, a transceiver configured by the mobile browser to facilitate markup language exchange with a plurality of Web pages, and a processor coupled to the memory and configured by the rendering module to render a separate browser window for each frame defined by the markup language.

In accordance with another embodiment of the invention, a computer-readable medium having instructions stored thereon which are executable by a mobile terminal for rendering browser windows is provided. The instructions perform steps comprising receiving markup definitions, parsing the markup definitions to find frame tags contained within the markup definitions, generating a content window for each frame tag found, generating a navigation window having a navigation tab for each frame tag found, and facilitating navigation between the content windows by selection of the navigation tab from the navigation window.

In accordance with another embodiment of the invention, a method for rendering browser windows is provided. The method comprises receiving markup definitions, parsing the markup definitions to find frame tags contained within the markup definitions, generating a content window for each frame tag found, and generating a navigation window having a navigation tab for each frame tag found.

In accordance with another embodiment of the invention, a method for navigating between browser windows generated by a mobile browser is provided. The method comprises generating a navigation window having a tab to represent each browser window, activating a browser window by selecting its corresponding tab in the navigation window, and providing a visual indication of the active browser window.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

The invention is described in connection with the embodiments illustrated in the following diagrams.

FIG. 1 illustrates a representative networking environment in which the principles of the present invention may be applied;

FIG. 2 illustrates a prior art rendering of an HyperText Markup Language (HTML) frame;

FIGS. 3-6 illustrate exemplary Extensible HyperText Markup Language (XHTML) frames rendered in accordance with the present invention;

FIG. 7 illustrates an exemplary rendering process in accordance with the principles of the present invention;

FIG. 8 illustrates an exemplary navigational flow chart in accordance with the principles of the present invention; and

FIG. 9 illustrates a representative mobile computing arrangement suitable for rendering Web pages in accordance with the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, apparatus, and method that allows rendering of XHTML content onto the display of a mobile device that promotes readability and improved navigation. The rendered frame is separated into two separate frames: a content frame and a navigation frame. The navigation frame is rendered as tabs, each tab providing the link to its corresponding, separately rendered content frame. Each content frame is accessible through the selection of its corresponding tab. Once the desired content frame is selected, the corresponding tab provides visible feedback to the user, for example, by blinking and changing its color or gray scale shading to indicate the selected content frame.

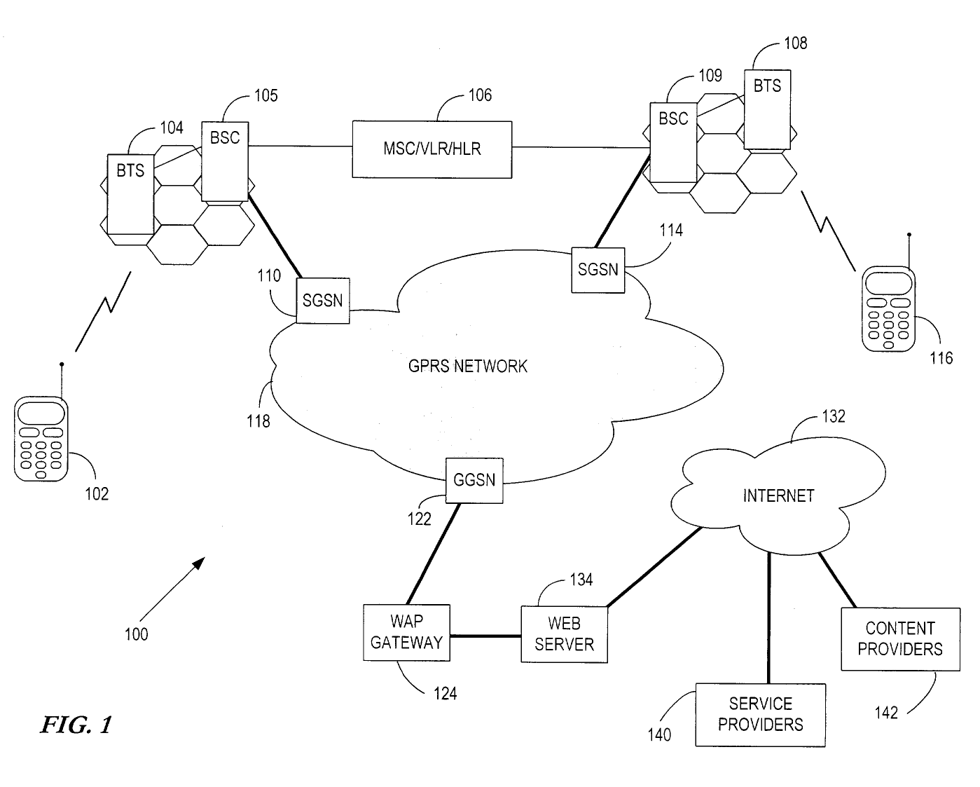

FIG. 1 illustrates exemplary communication system 100 in which the principles of the present invention may be utilized. Communication system 100 utilizes General Packet Radio Service (GPRS) network 118 as the communications backbone. GPRS is a packet-switched service for the Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 1 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Referring to FIG. 1, mobile terminals 102 and 116 communicate with Base Transceiver Station (BTS) 104 and 108, respectively, via an air interface. BTS 104 and 108 are components of the wireless network access infrastructure that terminates the air interface over which subscriber traffic is communicated to and from mobile terminals 102 and 116. Base Station Controller (BSC) 105 and 109 are switching modules that provide, among other things, handoff functions, and power level control in each BTS 104 and 108, respectively. BSC 105 and 109 controls the interface between a Mobile Switching Center (MSC) 106 and BTS 104 and 108, and thus controls one or more BTSs in the call set-up functions, signaling, and use of radio channels. BSC 105 and 109 also controls the respective interfaces between Serving GPRS Support Node (SGSN) 110 and BTS 104 and SGSN 114 and BTS 108.

SGSN 110 serves a GPRS mobile terminal by sending or receiving packets via a Base Station Subsystem (BSS), and more particularly via BSC 105 and 109 in the context of GSM systems. SGSN 110 and 114 are responsible for the delivery of data packets to and from mobile terminals 102 and 116, respectively, within the service area, and they perform packet routing and transfer, mobility management, logical link management, authentication, charging functions, etc. In the exemplary GPRS embodiment shown in FIG. 1, the location register of SGSN 110 stores location information such as the current cell and Visiting Location Register (VLR) associated with mobile terminal 102, as well as user profiles such as the International Mobile Subscriber Identity Number (IMSI) of all GPRS users registered with SGSN 110. SGSN 114 performs similar functions relating to mobile terminal 116. While GSM forms the underlying technology, SGSN 110 and 114 described above are network elements introduced through GPRS technology. Another network element introduced in the GPRS context is the Gateway GPRS Support Node (GGSN) 122, which acts as a gateway between the GPRS network 1118 and WAP gateway 124. Access to Internet 132 and corresponding service and content providers, 140 and 142 respectively, is provided to mobile terminals 102 and 116 via Web server 134.

WAP enhances the functionality of mobile terminals through real-time interactive services. The protocol has been specifically designed for small screens and low bandwidths, and it offers a wide variety of wireless services over the Internet for mobile devices. It was also designed to allow content to be delivered over any bearer service, even when delivery of the services is enabled over GPRS, 3G, or any other type of network. WAP over GPRS opens up new possibilities for application development and there are also some optimizations in GPRS that can be performed by service developers.

Application developers can use the principles of WAP to develop new services or adapt existing Internet applications for use with mobile devices. Applications are written in Wireless Markup Language (WML) and WMLScript (WMLS) and are stored on either Web server 134 or directly on WAP gateway 124. The content stored on Web server 134 is accessible from mobile devices 102 and 116 via GPRS network 118, GGSN 122, and WAP gateway 124. It is recommended to use a HyperText Transfer Protocol (HTTP) proxy (not shown) to cache WML content whenever the content is accessed via Internet 132. The proxy should either be co-located with WAP gateway 124 or proximately located next to WAP gateway 124 in order to minimize the delay in data transfer between the two components.

Mobile devices 102 and 116 access WAP gateway 124 using a GSM data call, where they supply a user-agent field within a Wireless Session Protocol (WSP) header when fetching content from Web server 134. WAP gateway 124 then encapsulates the WSP header within an HTTP header prior to sending to Web server 134. The WSP header is utilized by Web server 134 to, for example, determine the particular browser that is being utilized by mobile devices 102 and 116, so that suitable content may be delivered to mobile devices 102 and 116 by Web server 134.

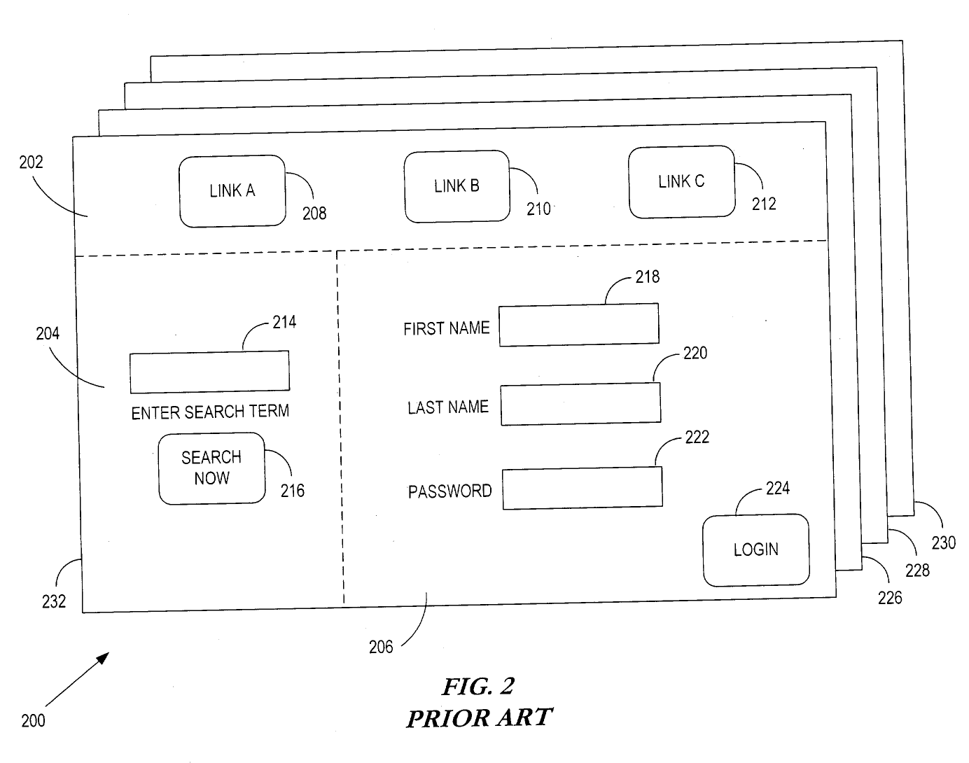

In the prior art as illustrated by screens 200 of FIG. 2, the first screen of any Web page frequently contains navigational links, e.g., 208-212, search fields, e.g., 214-216, and login screens, e.g., 218-222. Screens 200 of FIG. 2 are representative of home pages that may be obtained when accessing any URL located within, for example, Internet 132 of FIG. 1. It is apparent to one of ordinary skill in the art that screens 200 are merely used as a tool to describe the state of the art and are not intended to be representative of any restrictions to be associated with the state of the art.

Screen 232 of FIG. 2 is partitioned into three areas: 202; 204; and 206. Frame 202 represents an area containing navigational links that may be followed from screen 232. Link A 208, Link B 210, and Link C 212 represent navigational links contained within navigational area 202 that, when selected, causes the browser to fetch the home page contents of the URL represented by screens 226-230. Frame 204 represents a typical search partition found on many Web pages that allows the user to search for terms that may exist within the URL's domain. Search terms may be entered by the user into input block 214 and then searched for by selecting the “Search Now” button 216. Frame 206 represents a typical login screen partition that allows special users to authenticate themselves by entering their first name in input block 218, their last name in input block 220, and a password in input block 222. Once all of the information is entered, the user's validation may take place by selecting the “Login” button 224.

A typical XHTML code sequence that may be used to define areas 202-206 is presented in code sequence (I) below:

| | |
|---|---|
| <html xmlns=“http://www.w3.org/1999/xhtml”> | |
| <frameset rows=“25%,75%”> | |
| <frame src=“frame_202.htm” /> | |
| <frameset cols=“40%,60%”> | |
| <frame src=“frame_204.htm” /> | (1) |
| <frame src=“frame_206.htm” /> | |
| </frameset> | |
| </frameset> | |
| </html> | |

Code sequence (1) defines two horizontal areas by using the first frameset tag followed by attribute values for each of the two rows in the frame set. The first horizontal area defined by frame 202 claims 25% of the total area of the frameset, whereas the second horizontal area, defined by frames 204 and 206, claims 75% of the total area of the frame set. Within the second of the two horizontal areas, two columns are defined by the second frameset tag by setting attribute values for the two columns, e.g., 204 and 206, of the second horizontal area to 40% and 60%, respectively. Thus, frame 204 comprises 40% of the second horizontal area and frame 206 comprises 60% of the second horizontal area. The contents of each of the framesets defined by code sequence (1) are further defined by HTML files: frame_202.htm; frame_{—}204.htm; and frame_{—}206.htm; and they contain HTML code known in the art to generate frames 202, 204, and 206, respectively. It can be said, therefore, that the three frames defined by code sequence (1) are all opened within the same browser window in accordance with the prior art.

Although the three frames of screen 232 represent a relatively simplistic Web page, they nevertheless contain elements that prove to be challenging when rendered onto a reduced size display of a mobile device. For example, screen 232 in its entirety does not fit within the size constraints of the mobile device's display. As a result, the user is relegated to navigate within the elements of screen 232 by using, for example, the <left> and <right> keys on the keypad of the mobile device. In other words, each of elements 208-224 of screen 232 may be individually selected by the mobile device, simply by toggling through each element in sequential manner by pressing the <left> or <right> keys on the keypad. As each element is selected, it is highlighted or centered on the display of the mobile device so that the user knows which element is active at any given time.

Each of screens 226-230 are retrieved by following links 208-212, respectively, from screen 232. As each screen is accessed, the browser caches the URL into a previously viewed deck. The previously viewed decks are, therefore, relatively quickly accessed by simply pressing, for example, the <prev> and <next> keys on the mobile device to navigate between the previously viewed decks. One disadvantage of this form of deck navigation, however, is that each deck must be accessed in sequence in order to get to the next previously viewed deck. In other words, if screen 232 was the first screen accessed during a browsing session, followed by access to screens 226-230 in succession, then the prior art method of returning back to screen 232 requires that the <prev> key be pressed in succession several times in order to return to the original screen 232. For example, if screen 230 is the active screen displayed on the user's mobile device, then one press of the <prev> key loads the cached URL associated with screen 228. The next press of the <prev> key loads the cached URL associated with screen 226. One more final press of the <prev> key is required before the desired screen 232 is active on the user's display.

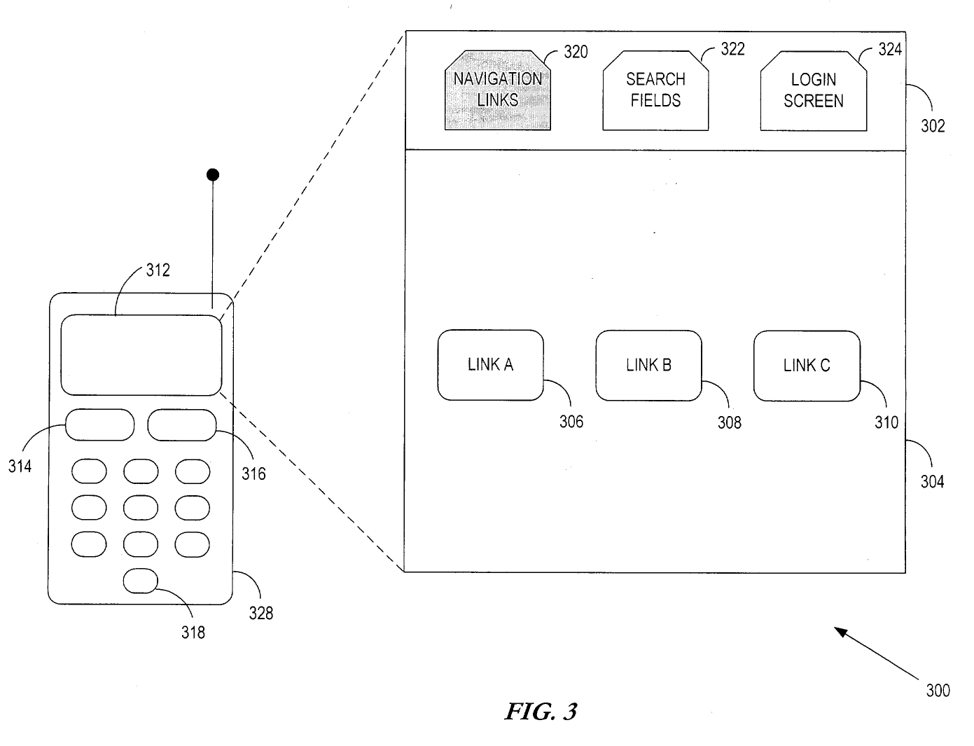

FIG. 3 illustrates exemplary display 300 according to the principles of the present invention. The browser executing within mobile device 328 renders code sequence (1) into a separate browser window for each frame that is defined within the code sequence, as opposed to rendering all frames into a single browser window as depicted in FIG. 2. For example, as the browser reads code sequence (1), a separate browser window is generated for each <frame> definition encountered. The contents of each <frame> definition are then rendered inside each of the browser windows created, thus creating a content window for each frame definition found. Once all of the content windows have been generated, a navigation window is then constructed. The navigation window is comprised of a separate tab for each content window that was previously generated. In order to retrieve a content window into the active portion of the display of the mobile device, the tab that corresponds to the content window is selected. Once a tab has been selected, a visual verification of the tab selection is provided to the user. In one embodiment, the selected tab may blink several times and then transition to a constant color shade that is noticeably darker than the other tabs contained within the navigation window. In general, any form of visual contrast may be used to indicate an active navigation tab, to include changing the size of the selected tab, highlighting just the border of the selected tab, alternating the size of the selected tab to generate a pulsing effect, changing the color of the selected tab, etc.

Frame 302 illustrates the navigation window created from code sequence (1), where tabs 320-324 represent the iconicized versions of frames defined by their corresponding XHTML definitions. For example, navigation links tab 320 is the iconicized version of the frame defined by “frame_{—}202.htm” in code sequence (1). Likewise, search fields tab 322 and login screen tab 324 are the iconicized versions of the frames defined by “frame_{—}204.htm” and “frame_-206.htm” respectively, in code sequence (1). In one embodiment, the labels given to each of tabs 320-324 may be derived from text labels provided in the corresponding XHTML definition files of the corresponding frames. In another embodiment, labels may be generated from the URL of the Web page that corresponds to the selected frame. For example, if the URL of screen 232 of FIG. 2 is “www.autotalli.com”, then the tab label associated with tab 320 may be set to “www.autotalli.com-1”. Similarly, tabs 322 and 324 may be set to “www.autotalli.com-2” and “www.autotalli.com-3”, respectively. In another embodiment, the user may be prompted by the mobile device to supply labels via keypad, or screen entry, while the browser is generating the navigation window. In general, however, tab labels may not be particularly relevant to the user, since many tab labels derived from the URLs tend to be quite lengthy and potentially unimportant.

Navigation between each of the content windows is performed exclusively by highlighting the corresponding tab within the navigation window and then selecting it. For example, by selecting the navigation links tab 320 of navigation window 302, the resulting content window 304 results, since the browser associates content window 304 with navigation tab 320. Note that content window 304 is similar to frame 202 of FIG. 2, except that elements 306-310 of the frame have been rendered according to the aspect ratio of content window 304, but in all other functional respects, the windows are equivalent. Each tab of navigation window 302 may be initially highlighted by pressing “prev” key 314 or “next” key 316. Once the desired tab is highlighted, “select” key 318 is pressed to cause the content window to change. A visual indication is then provided to the user to inform the user of the new content window selection. In one embodiment, the coloration or shading of tab 320 transitions to a color or shade that is noticeably darker than the color or shade of tabs 322 and 324 within navigation window 302. The tabs within navigation window 302 may be selected by any means afforded by the mobile device to include, for example: point and click, touch screen selection, voice commands, or acceleration/tilt sensor commands.

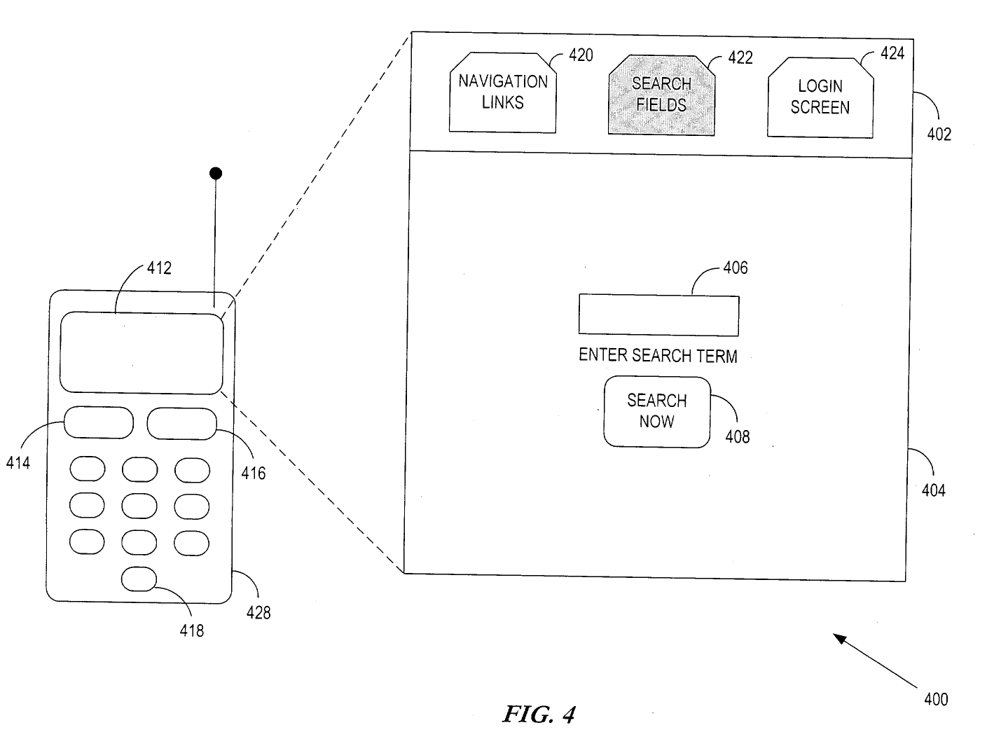

FIG. 4 illustrates alternate display 400 according to the principles of the present invention. In this example, the browser within mobile device 428 has rendered navigation window 402 and content window 404 onto display 412 according to the XHTML definition “frame_{—}204.htm” found in code sequence (1). Note that content window 404 is similar to frame 204 of FIG. 2, except that elements 406-408 of the frame have been rendered according to the aspect ratio of content window 404, but in all other functional respects, the windows are equivalent. Navigation window 402 provides navigation tabs 420-424 that are selected by using appropriate key press sequences of “prev” key 414, “next” key 416, and “select” key 418, or by other means to include, for example: point and click, touch screen selection, voice commands, or acceleration/tilt sensor commands. In one embodiment, the selection of the search fields content window is visually indicated by the shading associated with tab 422 being noticeably darker than tabs 420 and 424.

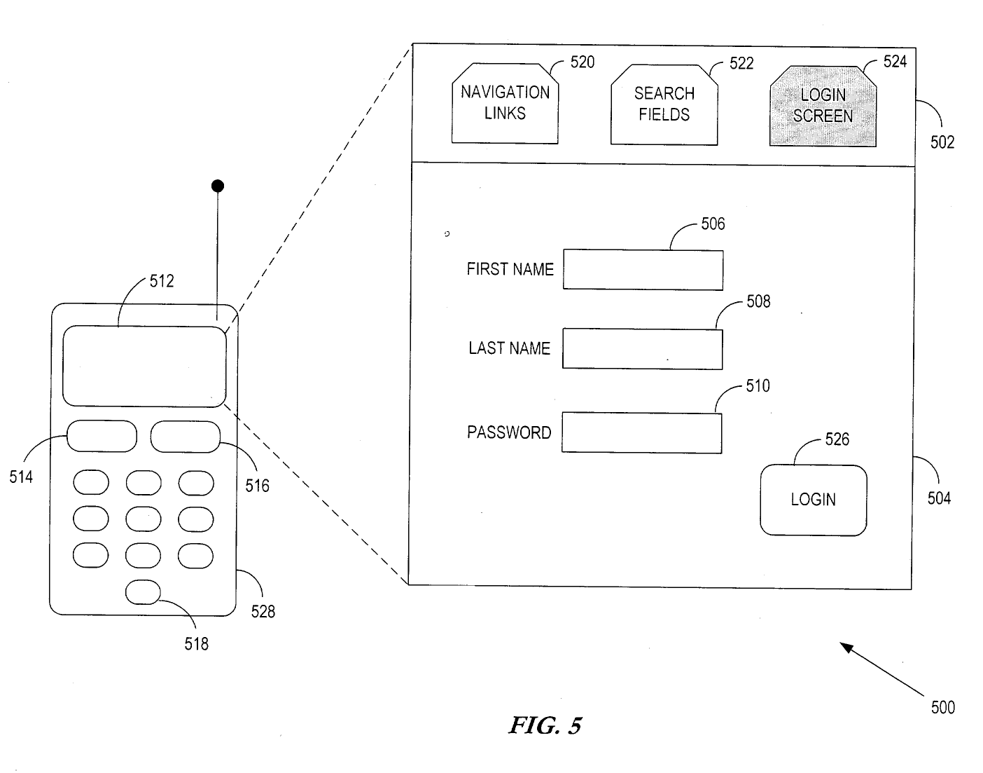

FIG. 5 illustrates alternate display 500 according to the principles of the present invention. In this example, the browser within mobile device 528 has rendered navigation window 502 and content window 504 onto display 512 according to the XHTML definition “frame_{—}206.htm” found in code sequence (1). Note that content window 504 is similar to frame 206 of FIG. 2, except that elements 506-510, and 526 of the frame have been rendered according to the aspect ratio of content window 504, but in all other functional respects, the windows are equivalent. Navigation window 502 provides navigation tabs 520-524 that are selected by using appropriate key press sequences of “prev” key 514, “next” key 516, and “select” key 518, or by other means to include, for example: point and click, touch screen selection, voice commands, or acceleration/tilt sensor commands. In one embodiment, the selection of the login screen content window is visually indicated by the shading associated with tab 524 being noticeably darker than tabs 520 and 522.

It should be noted that in each of FIGS. 3-5, navigation windows 302, 402, and 502 have remained structurally equivalent to each other, except for the visual feedback provided to the user. The visual feedback is provided to the user to allow him or her to determine at a glance which of the content windows, e.g., 304, 404, or 504, is active within the display of the mobile device. In addition, the navigation windows allow separation of navigational tools from the actual Web page content. Accordingly, presentation of the content to the user is better defined because the content windows are dedicated to providing Web page content, while the navigation window is dedicated to providing navigational content.

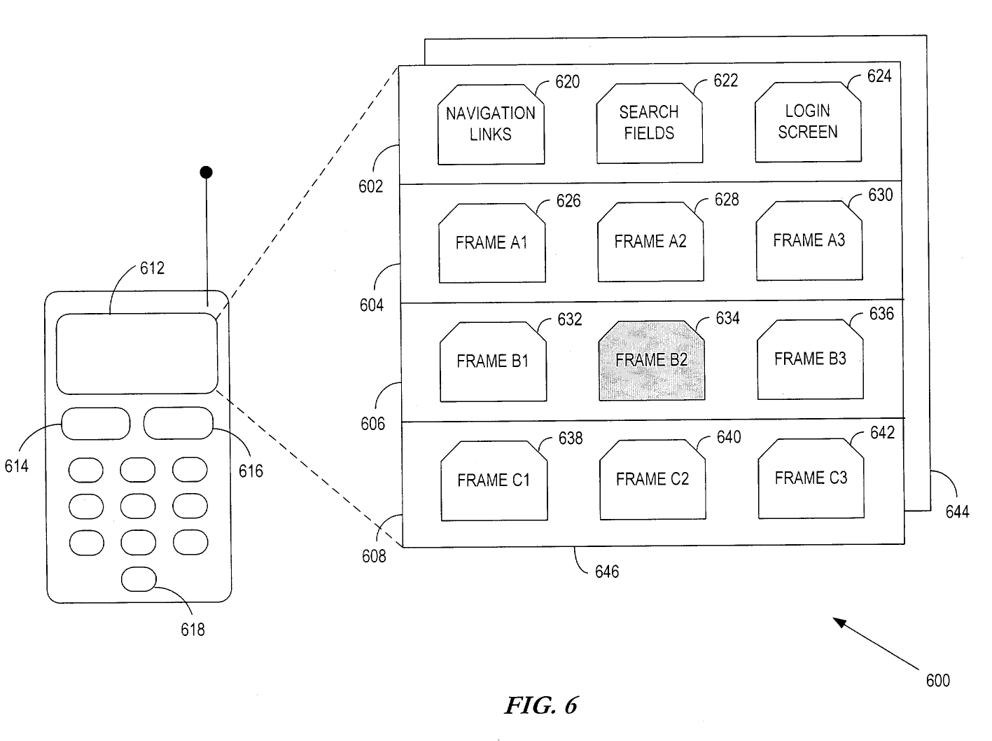

Additionally, the present invention allows improved navigation between linked URLs as illustrated through the use of FIG. 2 and alternate display 600 of FIG. 6. Referring back to FIG. 2, screens 226 through 230 represent the Web page contents at the URLs pointed to by Link A 208 through Link C 212, respectively. Navigation frame 602 provides the navigation window corresponding to screen 232 of FIG. 2 and contains navigation tabs 620-624. Similarly, navigation frames 604-608 represent the navigation windows for screens 226-230 of FIG. 2, respectively. Navigation frame 604 contains navigation tabs 626-630 that are the iconicized representations of Frames A1-A3, corresponding to screen 226. Similarly, navigation frame 606 contains navigation tabs 632-636 that are the iconicized representations of Frames B1-B3, corresponding to screen 228 and navigation frame 608 contains navigation tabs 638-642 that are the iconicized representations of Frames C1-C3, corresponding to screen 230.

Accordingly, navigation window 646 allows the user to navigate between all separately rendered content frames associated with screens 226-232, by simply selecting the navigation tab that corresponds to the desired frame. For example, if the user wishes to display the content associated with Frame B2 of Link B 210 onto content window 644, the user simply selects tab 634 from navigation window 646 and the content is automatically rendered to content window 644. In one embodiment, darkened tab 634 provides the visual feedback necessary for the user to immediately determine that Frame B2 of Link B 210 is the activated content in window 644. Further, if the user wishes to display the frame associated with login screen tab 624 onto content window 644, for example, then the user simply is required to select tab 624 from navigation window 646 and the login screen content is automatically displayed onto content window 644. Accordingly, the present invention allows direct navigation to desired frames without the need to sequentially traverse a linked list.

The mobile browser executing within the mobile device provides the mobile device with a new and near real-time interaction mode for several enabling technologies and thus provides the enabling technology for the present invention. The mobile browser, for example, can be used to access markup based services or to, for example, download and install Java applications to the mobile device. The mobile browser can also function as the search and delivery platform for content that the consumer wants to download to the mobile device, or even some other device. Additionally, the mobile browser handles XHTML and other supported content types, and may even support e-mail, Multimedia Messaging Service (MMS), and Java, when these services require support for the many content types that the mobile browser may also support.

The root of the browsing system relies on Web pages described in one of the available markup languages, e.g., XHTML, HTML, or WML. The Web pages can even contain non-visual passive, e.g., meta data, and active, e.g., scripting, elements that help to make each of the pages easier to locate, faster to access, better to view, and more secure to use. The mobile browser is the user agent within the mobile device that is required to handle markup content received, for example, from content providers 142 of FIG. 1.

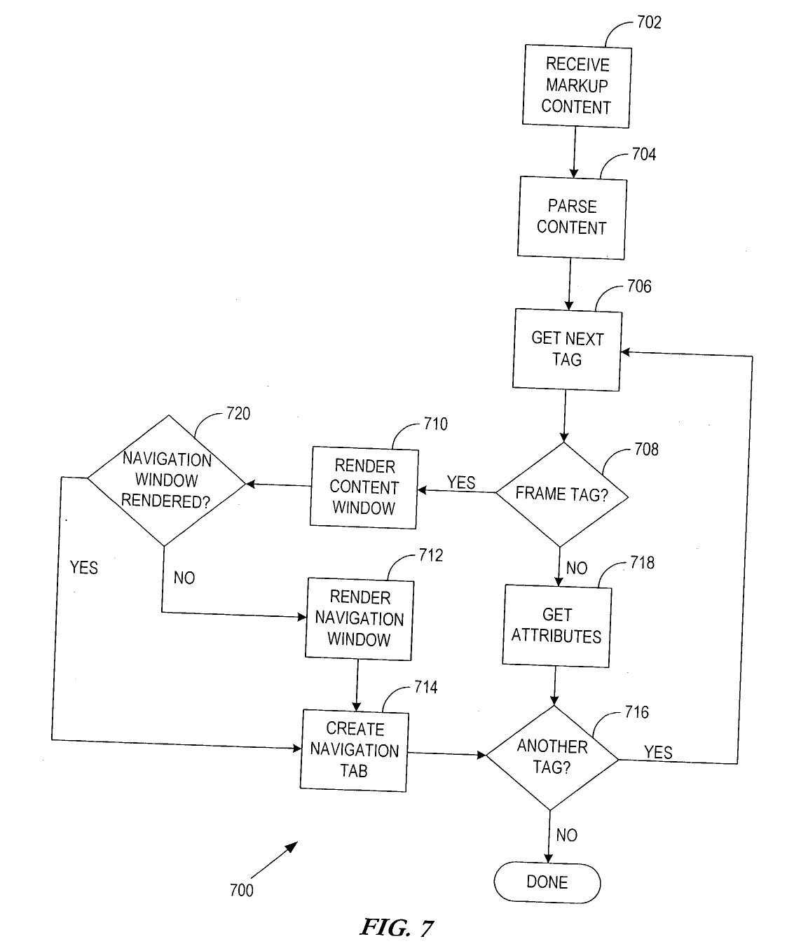

One of the main functions of the mobile browser according to the present invention is to parse the markup content, e.g., code sequence (1), that may be received from any URL accessed from Internet 132 of FIG. 1. Once parsed, the mobile browser is able to ascertain the layout of the navigation window, and the number of content windows needed to completely present the content provided by the URL and any other linked URLs that the user may have followed. FIG. 7 illustrates an exemplary rendering process 700 according to the present invention.

For purposes of explanation, code sequence (1) will be assumed to have been received in step 702 by the mobile browser according to the present invention. The mobile browser then proceeds to parse the content according to tags and associated attributes as shown in Table 1.

TABLE 1

| TAG # | TAG | ATTRIBUTE | DESCRIPTION |
|---|---|---|---|
| 1 | frameset | rows = 25%, 75% | First horizontal |
| | | | partition in content |
| | | | window. |
| 2 | frame src | frame_202.htm | Markup source code for |
| | | | first horizontal frame. |
| 3 | frameset | columns = 40%, 60% | Vertical partition of |
| | | | second horizontal |
| | | | partition in content |
| | | | window. |
| 4 | frame src | frame_204.htm | Markup source code for |
| | | | first vertical frame in |
| | | | second horizontal |
| | | | frame. |
| 5 | frame src | frame_206.htm | Markup source code for |
| | | | second vertical frame in |
| | | | second horizontal |
| | | | frame. |

Tag #1 is retrieved in step 706 and it is a frameset tag that defines the first horizontal frame, e.g., 202, of prior art Web page 200 of FIG. 2, therefore, the YES path from step 708 is taken. According to the present invention, a new content window is generated in step 710, e.g., 304 of FIG. 3, where the attributes of the frameset tag are ignored in lieu of rendering the new content window according to the pre-defined attributes of content window 304. The pre-defined attributes of content window 304 may, for example, be user defined at start up, maintained in a configuration file that is defined at the provisioning stage of the mobile device, or defined interactively as the window is being rendered by the mobile browser. A navigation window, e.g., 302, is rendered in step 712, since a navigation window had not been previously rendered as ascertained by step 720. icon, or navigation tab, e.g., 320, is then generated in step 714 and placed into the navigation window to aid in future navigation to frame 304. Similarly, the attributes of the navigation window may, for example, be user defined at start up, maintained in a configuration file that is defined at the provisioning stage of the mobile device, or defined interactively as the window is being rendered by the mobile browser.

Since there exist other tags, the YES path from step 716 is taken in order to retrieve Tag #2. Tag #2 is not a frame tag, therefore, no new content frames or navigation tags need to be generated and the NO path from step 708 is taken. Instead, the markup definition file for frame 304, e.g., frame_{—}202.htm, is retrieved in step 718 and rendered onto content window 304.

Since there exists other tags, the YES path from step 716 is taken in order to retrieve Tag #3. Tag #3 is a frameset tag that defines two vertical frames, e.g., 204 and 206, within the second horizontal frame of prior art Web page 200 of FIG. 2. Since there are two frames defined by Tag #3, the mobile browser according to the present invention generates two content windows in step 710, e.g., 404 of FIGS. 4 and 504 of FIG. 5, in accordance with pre-defined attributes, thus ignoring the attributes for the frames as defined by code sequence (1). Navigation tabs, e.g. 322 and 324, are then generated in step 714, thus bypassing step 712 as ascertained by step 720, and placed into the previously generated navigation window, e.g., 302.

Since there exist other tags, the YES path from step 716 is taken in order to retrieve Tag #4. Tag #4 is not a frame tag, therefore, no new content frames or navigation tags need to be generated and the NO path from step 708 is taken. Instead, the markup definition file for frame 404, e.g., frame_{—}204.htm, is retrieved in step 718 and rendered onto content window 404.

Since there exist other tags, the YES path from step 716 is taken in order to retrieve Tag #5. Tag #5 is not a frame tag, therefore, no new content frames or navigation tags need to be generated and the NO path from step 708 is taken. Instead, the markup definition file for frame 504, e.g., frame_{—}206.htm, is retrieved in step 718 and rendered onto content window 504. Since no other tags exist within code sequence (1), the NO path is taken from step 716 and the rendering completes.

Once the mobile browser has completed the rendering of the navigation window and all related navigation tabs, the user is free to navigate within the three content windows, e.g., 304, 404, and 504, accordingly. If the user selects one of links 306, 308, or 310 from content window 304, then the rendering process illustrated by FIG. 7 repeats itself, so that all navigation tabs and content windows may be generated as required by the Web pages pointed to by Links A, B, or C. The user is then free to navigate freely between all linked URLs and within all frames contained within the linked URLs according to the principles of the present invention.

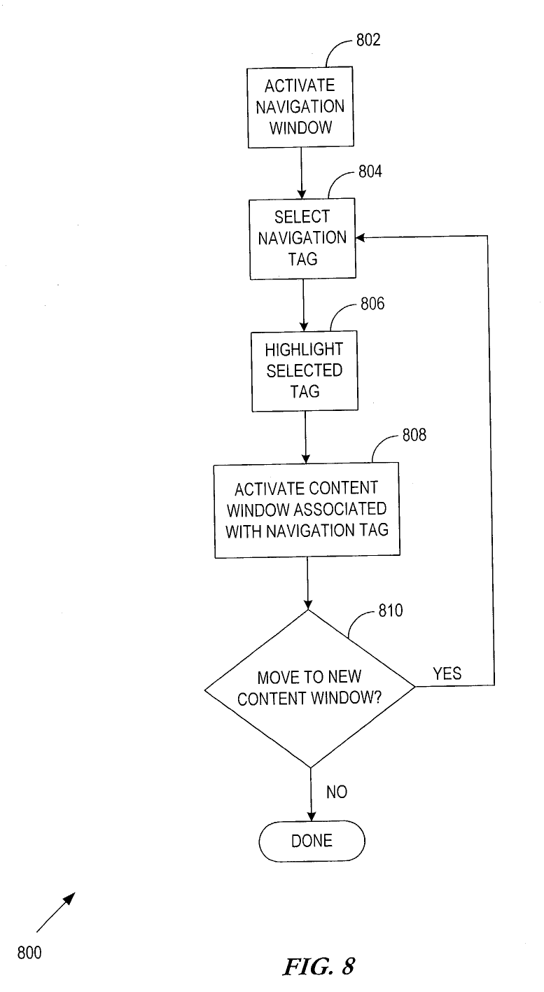

In particular, assuming that the user has traversed through each of Links A, B and C, for example, the navigation window 646 and content window 644 of FIG. 6 will result. The user is then free to execute navigation in accordance with the navigation flow chart of FIG. 8. Step 802 causes navigation window 646 to be activated on the user's mobile device display. The user is then free to select any one of the twelve navigation tabs, e.g., 620-642, as in step 804. Once selected, video feedback is provided to the user as in step 806 so that the user remains informed as to the content rendered onto content window 644 as in step 808. The user is then free once again to select any one of navigation tabs, e.g., 620-642, as in step 810 to render new content onto content window 644. It can be seen, therefore, that navigation according to the principles of the present invention is enhanced dramatically because the sequential backtracking through linked lists previously required by the prior art is eliminated.

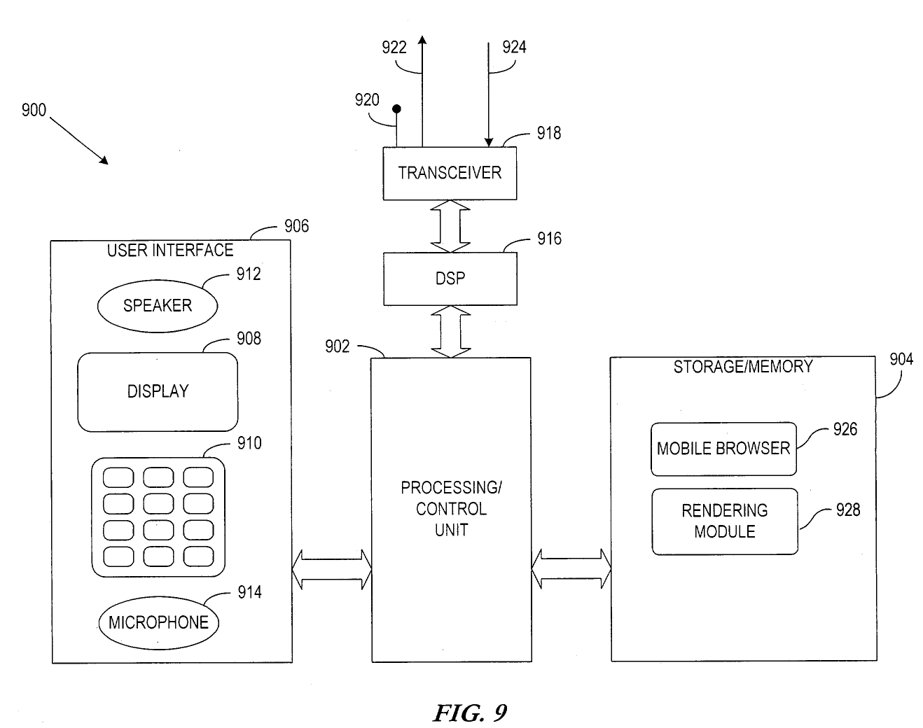

The invention is a modular invention, whereby processing functions within either a mobile terminal or a fixed terminal may be utilized to implement the present invention. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various browsing functions described herein. An example of a representative mobile terminal computing system capable of carrying out operations in accordance with the invention is illustrated in FIG. 9. Those skilled in the art will appreciate that the exemplary mobile computing environment 900 is merely representative of general functions that may be associated with such mobile devices, and also that landline computing systems similarly include computing circuitry to perform such operations.

The exemplary mobile computing arrangement 900 suitable for facilitating browsing functions in accordance with the present invention may be associated with a number of different types of wireless devices. The representative mobile computing arrangement 900 includes a processing/control unit 902, such as a microprocessor, reduced instruction set computer (RISC), or other central processing module. The processing unit 902 need not be a single device, and may include one or more processors. For example, the processing unit may include a master processor and associated slave processors coupled to communicate with the master processor.

The processing unit 902 controls the basic functions of the mobile terminal, and also those functions associated with the present invention as dictated by mobile browser 926 and rendering module 928 available in the program storage/memory 904. Thus, the processing unit 902 is capable of accessing markup content using mobile browser 926 and rendering it onto separate navigation and content windows using rendering module 928. The program storage/memory 904 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 904 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 900 via data signals, such as being downloaded electronically via one or more networks, such as the Internet and an intermediate wireless network(s).

The processor 902 is also coupled to user-interface 906 elements associated with the mobile terminal. The user-interface 906 of the mobile terminal may include, for example, a display 908 such as a liquid crystal display, a keypad 910, speaker 912, and microphone 914. These and other user-interface components are coupled to the processor 902 as is known in the art. Other user-interface mechanisms may be employed, such as voice commands, switches, touch pad/screen, graphical user interface using a pointing device, trackball, joystick, or any other user interface mechanism.

The mobile computing arrangement 900 also includes conventional circuitry for performing wireless transmissions. A digital signal processor (DSP) 916 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 918, generally coupled to an antenna 920, transmits the outgoing radio signals 922 and receives the incoming radio signals 924 associated with the wireless device.

The mobile computing arrangement 900 of FIG. 9 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a browsing system, apparatus, and method in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A network browsing system, comprising:
a network having Web pages addressable by a Uniform Resource Locator (URL); and
a browsing entity coupled to access the Web pages and coupled to receive markup definitions associated with the Web pages, wherein the browsing entity generates:
a content window for each frame associated with each Web page; and
a navigation window having a tab associated with each content window.

2. The network browsing system according to claim 1, wherein the browsing entity is contained within a mobile device.

3. The network browsing system according to claim 2, wherein the browsing entity comprises a parser to extract tag definitions from the markup definitions.

4. The network browsing system according to claim 3, wherein a tab is added to the navigation window for each frame tag definition found.

5. The network browsing system according to claim 3, wherein content is rendered onto each content window according to frame attributes extracted by the parser.

6. The network browsing system according to claim 1, wherein the navigation window contains tabs associated with a plurality of Web pages.

7. The network browsing system according to claim 6, wherein the content window is activated by selecting its corresponding tab in the navigation window.

8. The network browsing system according to claim 7, wherein the tab is visually highlighted when selected.

9. The network browsing system according to claim 8, wherein the tab is visually highlighted by blinking the tab.

10. The network browsing system according to claim 9, wherein the tab is further highlighted by shading the tab darker than other tabs contained within the navigation window.

11. The network browsing system according to claim 9, wherein the tab is further highlighted by coloring the tab a different color than other tabs contained within the navigation window.

12. The network browsing system according to claim 8, wherein the tab is selected by any one of point and click, touch screen selection, voice command, or acceleration/tilt sensor command.

13. A mobile terminal wirelessly coupled to a network having Web pages accessible by a Uniform Resource Locator (URL), the mobile terminal comprising:
a memory capable of storing at least one of a mobile browser and a rendering module;
a transceiver configured by the mobile browser to facilitate markup language exchange with a plurality of Web pages; and
a processor coupled to the memory and configured by the rendering module to render a separate browser window for each frame defined by the markup language.

14. The mobile terminal according to claim 13, wherein the processor is configured by the rendering module to render a navigation window.

15. The mobile terminal according to claim 14, wherein the navigation window contains tabs relating to each browser window.

16. The mobile terminal according to claim 15, wherein the browser window is activated by selection of its corresponding tab in the navigation window.

17. The mobile terminal according to claim 16, wherein the tab selected is visually highlighted.

18. The mobile terminal according to claim 17, wherein the tab is visually highlighted by blinking the tab.

19. The mobile terminal according to claim 18, wherein the tab is further visually highlighted by shading the tab darker than other tabs contained within the navigation window.

20. The mobile terminal according to claim 18, wherein the tab is further visually highlighted by coloring the tab a different color than other tabs contained within the navigation window.

21. The mobile terminal according to claim 16, wherein the tab is selected by any one of point and click, touch screen selection, voice command, or acceleration/tilt sensor command.

22. A computer-readable medium having instructions stored thereon which are executable by a mobile terminal for rendering browser windows by performing steps comprising:
receiving markup definitions;
parsing the markup definitions to find frame tags contained within the markup definitions;
generating a content window for each frame tag found;
generating a navigation window having a navigation tab for each frame tag found; and
facilitating navigation between the content windows by selection of the navigation tab from the navigation window.

23. A method for rendering browser windows, comprising:
receiving markup definitions;
parsing the markup definitions to find frame tags contained within the markup definitions;
generating a content window for each frame tag found; and
generating a navigation window having a navigation tab for each frame tag found.

24. The method according to claim 23, wherein the content window is rendered from attributes associated with each frame tag found.

25. A method for navigating between browser windows generated by a mobile browser, comprising:
generating a navigation window having a tab to represent each browser window;
activating a browser window by selecting its corresponding tab in the navigation window; and
providing a visual indication of the active browser window.

26. The method according to claim 25, wherein the browser windows represent a plurality of Web pages.

27. The method according to claim 26, wherein any browser window may be activated by selecting a single tab within the navigation window.

28. The method according to claim 27, wherein the tab is visually highlighted to indicate its selection.

29. The method according to claim 28; wherein the visual highlight includes blinking the selected tab.

30. The method according to claim 28, wherein the visual highlight further includes shading the tab darker than other tabs contained within the navigation window.

31. The method according to claim 28, wherein the visual highlight further includes coloring the tab a different color than other tabs contained within the navigation window.

32. The method according to claim 27, wherein the tab is selected by any one of point and click, touch screen selection, voice command, or acceleration/tilt sensor command.
